(19) United States
(12) Patent Application Publication
(10) Pub. No.: US 2007/0112924 A1
(43) Pub. Date: May 17, 2007

(54) METHOD FOR INSTANT COMMUNICATION THROUGH INTERNET

(75) Inventors: Chen Ko, Taipei City (TW); Chung-Jen Huang, Taipei City (TW); Chi-Yuan Chen, Taipei City (TW); Chih-Shin Lan, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: SYNAGE TECHNOLOGY CORPORATION, Taipei City (TW)

(21) Appl. No.: 11/464,201

(22) Filed: Aug. 13, 2006

(30) Foreign Application Priority Data
Nov. 17, 2005 (TW) 94140406

(51) Int. Cl. G06F 15/16

(52) U.S. Cl. 709/206; 709/227

(57) ABSTRACT

A method for instant communication through the Internet is provided. The method provides the users to instantly communicate with the online registered members through a web page connection without having to install software and register an account. In addition, the method provides Internet service providers with a purchase channel, such that the customer can communicate with the client service representatives instantly. Accordingly, the purpose of enhancing the convenience of instant Internet communication and Internet service is achieved.

### CROSS-REFERENCE TO RELATED APPLICATION

This application claims the priority benefit of taiwan application serial no. 94140406, filed on Nov. 17, 2005. All disclosure of the taiwan application is incorporated herein by reference.

### BACKGROUND OF THE INVENTION

1. Field of the Invention

The present invention relates to a communication method, and more particularly, to a method for instant communication by using the web browser through the Internet.

2. Description of the Related Art

In the busy modern life, since the Internet and the information environment are well developed, more and more people use electronic media to communicate with each other. Here, the electronic media may be the cellular phones, the Personal Digital Assistants (PDA), or the computers. In addition, software such as e-mail, instant messenger and bulletin board system (BBS) is commonly used as a communication tool. Wherein, since the instant messenger can provide a user with transmitting voice and text messages to other users instantly, the instant messenger has become the most popular communication software.

In general, when the user intends to communicate with other users by using the instant messenger software, the user has to register and become a member of the instant messenger software company first. In addition, before the user can instantly communicate with other registered users, the user has to log in and provide his/her user id and password to the instant messenger server when using the instant messenger communication software. FIG. 1 schematically shows a conventional configuration of instant communication through the Internet. As shown in FIG. 1, if a user A intends to communicate with a user B through the Internet, both of them have to install the instant messenger software and log in to the instant messenger server before they can communicate with each other on line.

FIG. 2 is a flow chart illustrating a conventional method for instant communication through the Internet. First, the user has to connect to the website of the instant messenger software company through the Internet to download and install the instant messenger software (step S210). Then, the user executes the instant messenger software (step S220). Meanwhile, whether the user has registered or not is determined (step S230). If the user has not registered yet, the instant messenger software requests the user to register online (step S240). After the user has registered, the user has to log in to the instant messenger software by inputting his/her user id and password (step S250). If the user is a registered member, the user directly inputs the user id and password to log in to the instant messenger software (step S250). After the user has logged in, the user checks whether the member he/she intends to communicate with is online or not (step S260). If the member he/she intends to communicate with does not log in, they wouldn't be able to chat with each other (step S280). If the member he/she intends to communicate with has logged in, a chat box is opened to start the chat (step S270). Finally, the conversation is terminated (step S280).

It is known from the description mentioned above that the conventional method for instant communication requires the user to download and install the instant messenger software. In addition, the user has to input his/her personal information in order to register as a member of the instant messenger software before logging in and using the instant communication function. For the users who are not familiar with computers, such method will be a great inconvenience.

Moreover, among all the registered members, 80% of them may only talk to each other once, it is unnecessary for both parties to remember each other's account, and it is quite annoying for user's account management. In addition, the instant messenger software such as MSN usually has a limitation of the number of members in the contact list. For example, each user is allowed to have a maximum of 300 members in the personal contact list, which is not convenient to the users. Accordingly, it will be more convenient for the users if there is a mechanism for the registered members who only communicate once. Especially for the governments or the service centers that use such type of instant messenger software to communicate with their clients, this mechanism will provide a great convenience to the users.

### SUMMARY OF THE INVENTION

Therefore, it is an object of the present invention to provide a method for instant communication through the Internet. The method allows a non-registered user to directly communicate with the registered user through the web page, such that the tedious procedures such as the software installation and account registration are eliminated, and the purpose of enhancing the convenience of instant communication for the users is achieved.

The present invention provides a method for instant communication through the Internet. The method allows the user to communicate with the members of the instant messenger software through the web page. First, the user links to the web page and checks whether the member he/she intends to communicate with is online or not. Then, the user inputs the user id and his/her e-mail address on the web page. Afterwards, the user opens a chat box to chat with other members. Finally, the conversation is completed.

In the method for instant communication through the Internet according to an embodiment of the present invention, the step of checking whether the member he/she intends to communicate with is online or not includes displaying the personal login status of the members of the instant messenger software, and allowing the user to choose a member to communicate with.

The method for instant communication through the Internet according to an embodiment of the present invention further includes: repeating the steps of linking to the web page, checking whether the member he/she intends to communicate with is online or not, inputting the user id and e-mail address on the web page, opening the chat box, and starting to chat, such that multiple users can communicate with multiple members of the instant messenger software. Wherein, the user id may be either the account name registered in the ISP (Internet Service Provider) or the user's name.

In the method for instant communication through the Internet according to an embodiment of the present invention, after inputting the user id and e-mail address, the method further provides multiple channels for the user to connect with.

In the method for instant communication through the Internet according to an embodiment of the present invention, after inputting the user id and e-mail address, the method further includes checking whether there is an available channel to connect with, if there is, activating the channel for the user to connect with; if there is not, issuing a message to notify the user.

In the method for instant communication through the Internet according to an embodiment of the present invention, after the conversation is completed, the channel is released.

In the method for instant communication through the Internet according to an embodiment of the present invention, after the chat starts, the messages are recorded in a database of the instant messenger software, and the messages recorded in the database are sent to the e-mail address of the user after the conversation is completed.

In the method for instant communication through the Internet according to an embodiment of the present invention, the messages mentioned above include voice messages or instant text messages.

The present invention provides a mechanism for the user to instantly chat with others through the web page, such that a non-registered user can instantly communicate by voice or text messages with the registered members without having to install the instant messenger software. Accordingly, the purpose of enhancing the convenience of instant communication for the user is achieved.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 schematically shows a conventional configuration of instant communication through the Internet.

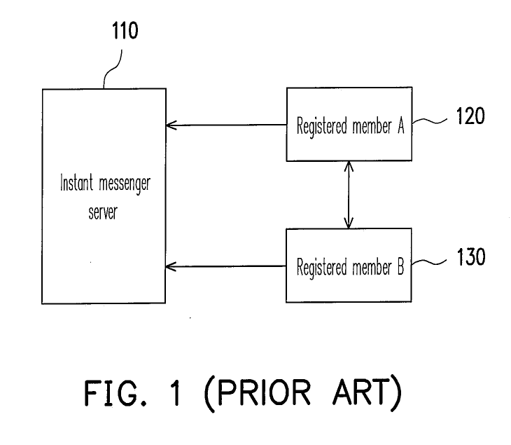

FIG. 2 is a flow chart illustrating a conventional method for instant communication through the Internet.

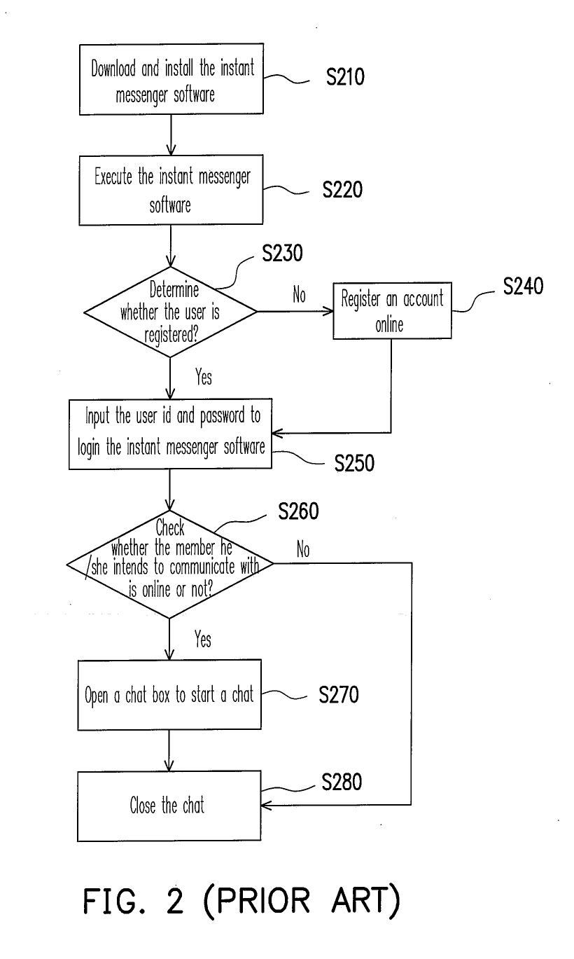

FIG. 3 schematically shows a configuration of instant communication through the Internet according to an embodiment of the present invention.

FIG. 4 is a flow chart illustrating a method for instant communication through the Internet according to an embodiment of the present invention.

FIG. 5 schematically shows a configuration of instant communication through the Internet according to another embodiment of the present invention.

FIG. 6 is a flow chart illustrating a method for instant communication through the Internet according to another embodiment of the present invention.

### DESCRIPTION OF EMBODIMENTS

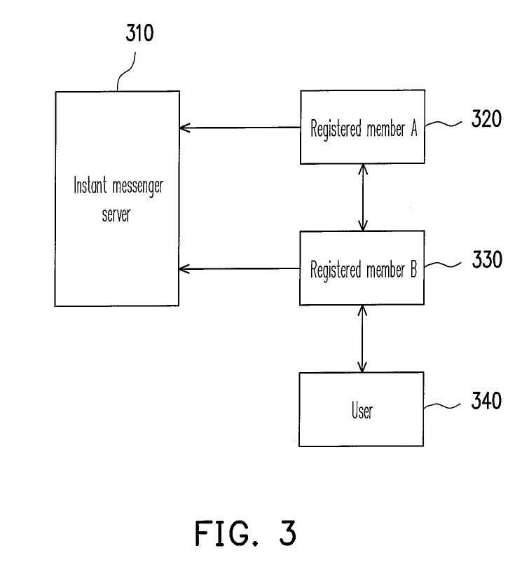

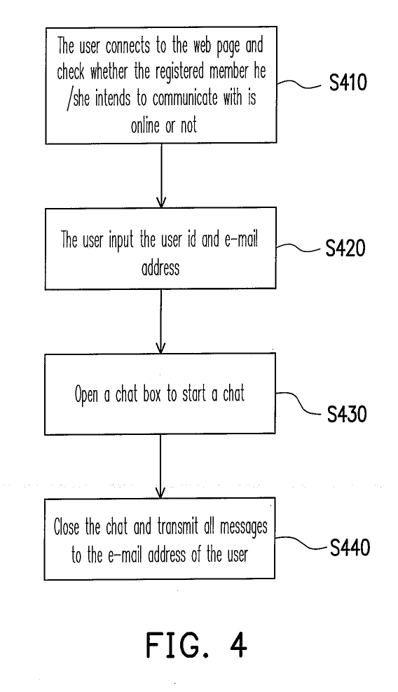

FIG. 3 schematically shows a configuration of instant communication through the Internet according to an embodiment of the present invention. The configuration includes an instant messenger server 310, a registered member A320, a registered member B330, and a non-registered user 340. Wherein, an instant messenger software is installed in the computers that are used by the registered members A320 and B330, and both users have registered as the members of the instant messenger software. After logging in to the instant messenger server 310, the registered members A320 and B330 can start to chat with each other through this instant messenger software or to transmit instant voice or text messages. In addition, the user 340 does not need to install the instant messenger software. When the user 340 intends to chat with the registered member 330, as long as the user 340 has linked to the web page through the web browser, the user can instantly chat with the registered member 330 through the Internet, and the detail flow of this chat is as shown in FIG. 4.

FIG. 4 is a flow chart illustrating a method for instant communication through the Internet according to an embodiment of the present invention. Referring to FIG. 4, first the user 340 links to the web page of an instant messenger software company and checks whether the registered member 330 he/she intends to communicate with is online or not through the web page (step S410). Since the web page is linked to the instant messenger server 310, the personal login status of the online registered members is shown in the web page, such that the user 340 can choose the registered member he/she intends to communicate with on the web page or the instant messenger server 310 may automatically assign a member on the web page for the user to start the connection.

Then, the web page requests the user 340 to input the user id and e-mail address (step S420). Wherein, the user id may be either the account name registered in the ISP (Internet Service Provider) or the user's name just use to identify himself but not necessarily limited to it.

Then, a chat box is opened to provide a facility for the user to start the chat (step S430). Wherein, the chat may be either voice or instant text messages but not necessarily limited to it. While the users are chatting with others, the messages are recorded in a database of the instant messenger software. Finally, after the conversation is completed, the messages stored in the database are sent to the e-mail address previously input by the user 340 (step S440).

It is known from the flow chart illustrated above, the present invention differs from the conventional instant messenger software in that the user can instantly communicate with the registered members through the web page without the necessary to register an account and install the instant messenger software. In addition, after the registered members have logged in, their personal login status is shown in the Internet so as to allow others to chat with them.

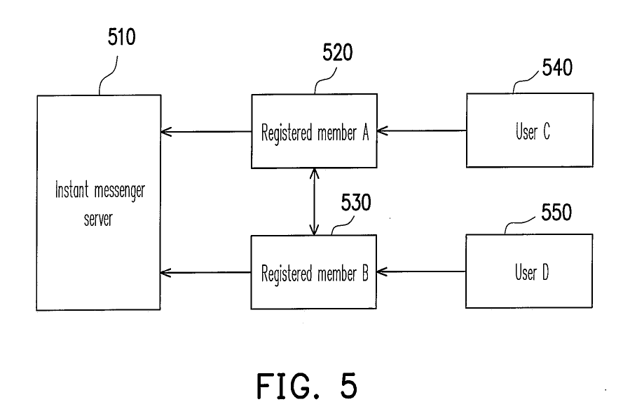

Moreover, in an embodiment of the present invention, the instant messenger software company further provides a plurality of channels for the users to connect with. FIG. 5 schematically shows a configuration of instant communication through the Internet according to another embodiment of the present invention. Referring to FIG. 5, the configuration of instant communication through the Internet of the present embodiment includes an instant messenger server 510, a registered member A520, a registered member B530, a user C540, and a user D550. If the instant messenger software company only provides two channels for the accounts in the present embodiment, in such case only two users (e.g. the users C540 and D550) can log in to the instant messenger server 510 and chat with the registered members A520 and B530, respectively.

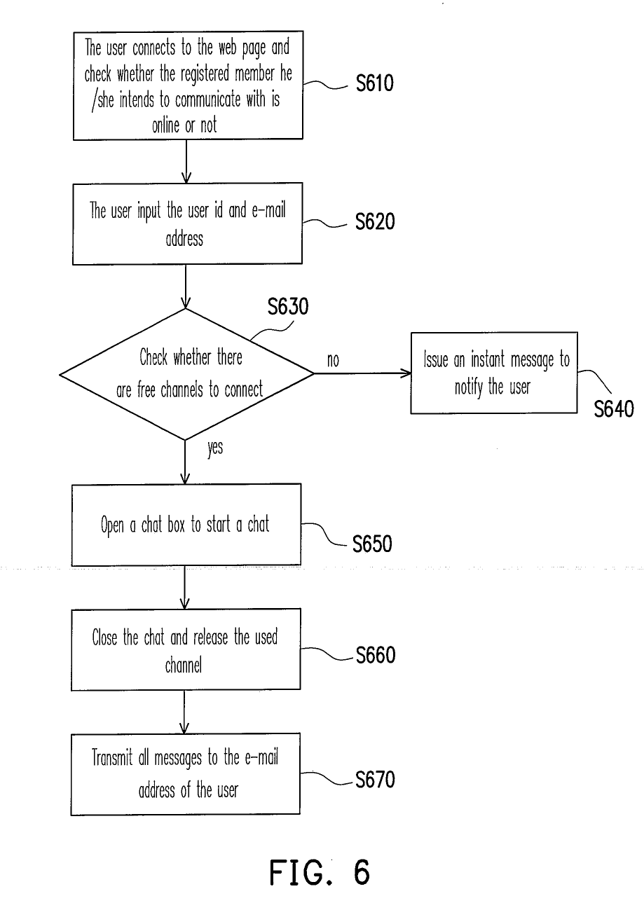

FIG. 6 is a flow chart illustrating a method for instant communication through the Internet according to another embodiment of the present invention. First, the user links to the web page and checks whether the member he/she intends to communicate with is online or not (step S610). Then, the web page requests the user to input the user id and e-mail address (step S620). The above two steps are the same as the previous embodiment, thus their details are omitted herein.

In addition, if the instant communication cannot be used due to the fact that the registered member he/she intends to communicate with is not online or is chatting with someone else, meanwhile, the user can transmit the content of the messages to the registered member through e-mail. In other words, the system also provides a non-real time e-mail service to the customers in case the instant communication cannot be accessed.

After the user's id and e-mail address are provided, the instant messenger server 510 checks whether there is a free channel to connect with (step S630). If there is no free channel (for example, in the previous embodiment, two channels are occupied by the users C540 and D550), the instant messenger server 510 immediately issues an instant message to notify the user on the web page (step S640).

If there are one or more free channels, a chat box is opened and the user can start to chat (step S650). Wherein, the chat may be either a voice chat or instant text message but not necessarily limited to it. In addition, while the user is chatting with others, the messages are all recorded in the database of the instant messenger software.

After the conversation is completed, the used channel is released (step S660), and the messages stored in the database are sent to the e-mail address previously input by the user (step S670). After the used channel is released, the user log out timestamp is written into a user status log file of the system, such that the system can provide the released channel for a next user to log in.

Moreover, with the method mentioned above for limiting the maximum channel number, the instant messenger software company can provide channels for other Internet service providers to purchase (e.g. the after-sales product support or the online shopping service provider). Thus, as long as the customer links to the web page of the service provider through the Internet, the customer can select one of the online service representatives on the web page by using the instant messenger function to query the product information or to place an order. Such method is similar to the toll free telephone service and is very convenient to the customers.

In summary, with the method for instant communication through the Internet provided by the present invention, the user can instantly chat with the registered member by linking to the web page without the necessary to install the software and register an account. In addition, the method also provides Internet service providers with a purchased channel, such that the customer can communicate with the client service representatives instantly. Accordingly, the purpose of enhancing the convenience of instant Internet communication and Internet service is achieved.

Although the invention has been described with reference to a particular embodiment thereof, it will be apparent to one of the ordinary skills in the art that modifications to the described embodiment may be made without departing from the spirit of the invention. Accordingly, the scope of the invention will be defined by the attached claims not by the above detailed description.

What is claimed is:

1. A method for instant communication through the Internet, suitable for providing a user to chat with a member of an instant messenger software through a web page, the method comprising:
(a) linking to the web page and checking whether the member he/she intends to communicate with is online or not;
(b) inputting a user id and an e-mail address on the web page;
(c) opening a chat box to start a chat; and
(d) closing the chat.

2. The method for instant communication through the Internet of claim 1, wherein the step (a) further comprises:
(a1) displaying a personal login status of the member of the instant messenger software.

3. The method for instant communication through the Internet of claim 2, wherein after the step (a1) further comprises:
(a2) allowing the user to choose the member on the web page.

4. The method for instant communication through the Internet of claim 3, further comprising:
repeating the step (a), the step (b), and the step (c) for allowing a plurality of users to chat with a plurality of members of the instant messenger software.

5. The method for instant communication through the Internet of claim 2, wherein after the step (a1) further comprises:
(a2) automatically assigning the member on the web page for the user.

6. The method for instant communication through the Internet of claim 5, further comprising:
repeating the step (a), the step (b), and the step (c) for allowing a plurality of users to chat with a plurality of members of the instant messenger software.

7. The method for instant communication through the Internet of claim 6, wherein after the step (b), further comprises:
(b1) providing a plurality of channels for the users to connect with.

8. The method for instant communication through the Internet of claim 7, wherein after the step (b1), further comprises:
(b2) checking whether there is any available channel to be connected with, opening the channels for connection if there are available channels; and
issuing a message to notify the user if there is no available channel.

9. The method for instant communication through the Internet of claim 8, wherein after the chat is closed, further comprises releasing the channels.

10. The method for instant communication through the Internet of claim 1, further comprising:
once the chat is started, recording all messages in a database of the instant messenger software; and
after the chat is closed, transmitting the messages recorded in the database to the e-mail address of the user.

11. The method for instant communication through the Internet of claim 1, wherein the chat comprises either a voice chat or an instant text message.

12. The method for instant communication through the Internet of claim 1, wherein the user id comprises an account name registered in the ISP (Internet Service Provider) or a user's name.
